(19) United States
(12) Patent Application Publication
(10) Pub. No.: US 2008/0076655 A1
(43) Pub. Date: Mar. 27, 2008

(54) METHOD OF MANUFACTURING STONE-LIKE ARTICLES

(75) Inventors: Jakinee Eamsiri, Muang (TH); Rachaneekorn Ruamthawee, Bangkok (TH); Chatree Thitianan, Bangkok (TH); Karn Nitayasuthi, Bangkok (TH)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: SCG Building Materials Company Limited, Bangkok (TH)

(21) Appl. No.: 11/859,324

(22) Filed: Sep. 21, 2007

(30) Foreign Application Priority Data
Sep. 22, 2006 (TH) 0601004684

(51) Int. Cl. C03C 1/02

(52) U.S. Cl. 501/32

(57) ABSTRACT

A method of manufacturing an article includes granulating glass, clay, filler, and porosity reducing agent to form a mixture, adding binder to the mixture to form granular particles, forming the granular particles into a shaped article by dry pressing, drying the shaped article, and firing the shaped article in a kiln at a maximum temperature of between about 800° C. and about 1100° C. The glass, clay, filler, and porosity reducing agent are granulated in a fluidized bed granulator. Upon addition of the binder, granulated particles are formed having an average particle size of between about 0.08 millimeters and about 5 millimeters. The granular particles comprise between about 55% to about 99% glass by weight, up to about 40% clay by weight, up to about 30% filler by weight, between about 0.1% and about 5% porosity reducing agent by weight, and between about 0.2% and about 3% binder by weight.

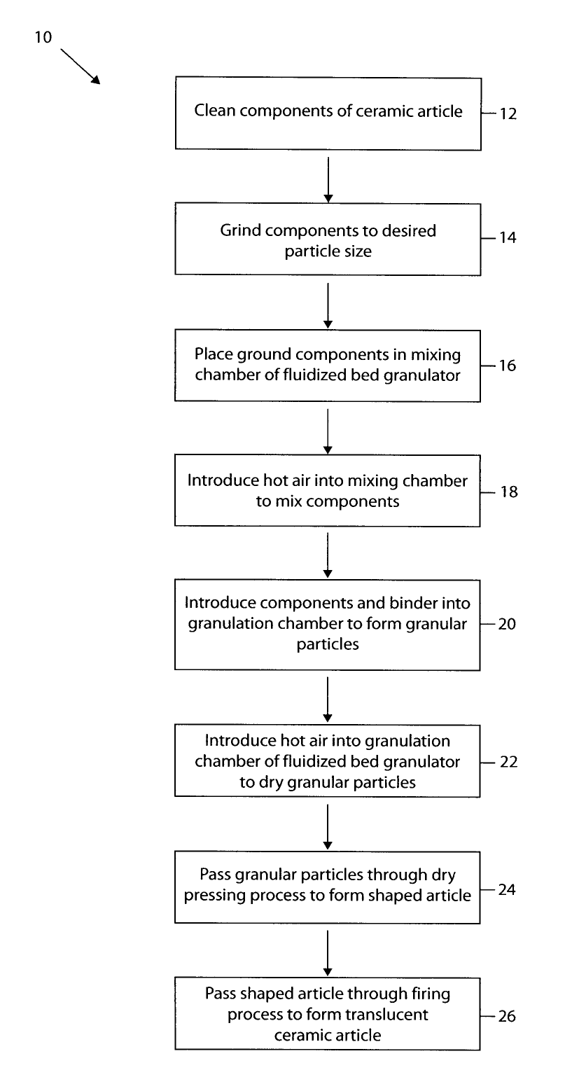

### CROSS-REFERENCE TO RELATED APPLICATION

This application claims priority to That Application No. 0601004684, filed Sep. 22, 2006, which is incorporated herein by reference in its entirety.

### TECHNICAL FIELD

The present invention relates generally to the field of manufacturing articles having translucent and stone-like properties. In particular, the present invention relates to a low-energy consuming method of manufacturing articles having translucent and stone-like properties.

### BACKGROUND

Articles having translucent or stone-like properties can provide an aesthetically pleasing and natural-feeling environment. For example, translucent articles may be used to create a luminous floor or wall (i.e. a floor covered by the translucent articles with lights underneath it), or may be used as an interior surface covering. Conventionally, articles having translucent or stone-like properties have been produced primarily using either a clay-based method or an amorphous-based method. The clay-based method generally involves using natural raw materials having very low iron content at high firing temperatures (i.e. between about 1100° Celsius (° C.) and about 1300° C.). The raw materials used in the clay-based method include, for example, milled clay, feldspar, and sand. The raw materials are mixed together with water to form a slurry which is subsequently spray-dried to obtain granular particles. After formation, the granular particles are compacted into tile form to produce a translucent ceramic article. This method allows the production of large-sized articles that are translucent to opaque and that also have a minimal number of pores. Compared to other granule formation methods (e.g. spray drying), the adopted process consumes less energy.

The amorphous-based method involves using a frit cullet having a large-sized refractory as the mold. In a first amorphous-based method, the method utilizes a loose form of frit or glass cullets having particle sizes of between about 0.1 centimeters (cm) and about 2 cm. The loose frit or glass cullets are placed in a refractory mold and fired at temperatures of between about 1200° C. and about 1300° C. for about 8 hours to about 12 hours. This method is also capable of producing large-sized translucent articles. However, the product may include both small and large pores. In addition, the frit cullets and high energy consumption during the firing step make the method costly. In a second amorphous-based method, glass powder having average particle sizes of between about 1 micron and about 200 microns are compacted into tile form. While the firing process may be carried out at temperatures as low as about 1000° C., this method produces only small-sized articles.

### SUMMARY

In one aspect, the present invention is a method of manufacturing an article. The method includes granulating glass, clay, filler, and porosity reducing agent to form a mixture, adding binder to the mixture to form granular particles, forming the granular particles into a shaped article by dry pressing, drying the shaped article, and firing the shaped article in a kiln at a maximum temperature of between about 800° C. and about 1100° C. The glass, clay, filler, and porosity reducing agent are granulated in a fluidized bed granulator. Upon addition of the binder, granulated particles are formed having an average particle size of between about 0.08 millimeters and about 5 millimeters. The granular particles comprise between about 55% to about 99% glass by weight, up to about 40% clay by weight, up to about 30% filler by weight, between about 0.1% and about 5% porosity reducing agent by weight, and between about 0.2% and about 3% binder by weight.

In another aspect, the present invention is an article formed using the method described above.

### BRIEF DESCRIPTION OF THE DRAWINGS

The sole FIGURE is a method of manufacturing an article having translucent and stone-like properties.

### DETAILED DESCRIPTION

The present invention is a method of manufacturing articles having a natural appearance. In an exemplary embodiment, the article is exhibits translucent and stone-like properties. The translucent and stone-like properties may give the article an appearance similar to, for example, marble. The method uses various types of glass, clays, fillers, porosity reducing agents, and binders as the raw material components. The method is a dry method and generally includes the steps of grinding the raw material components, forming granular particles from the raw materials through fluidized bed granulation, pressing the granular particles, and firing and polishing the granular particles to form a shaped article. The resulting article obtained using the method of the present invention has low water absorption and high strength. The low water absorption of the article results in a product that is less prone to mildew or other microorganism growth. In an exemplary embodiment, the resulting article has a water absorption lower than about 0.1%. The porosity reducing agent also reduces the number of pores the article will have in the body, increasing the density and overall strength of the article. In addition, the article may be translucent, making it more aesthetically pleasing than clay-based articles. The fluidized bed granulation process and the firing process used in the present method require less energy than most granulating processes and clay-based firing processes, respectively, thus resulting in decreased energy consumption.

The translucency of the article produced by the method of the present invention is observable through visual inspection. For example, the translucency of the article is high enough for a human to “see the depth” of the article. The raw material components required to produce the article generally include glass, clay, filler, porosity reducing agent, and a binder. Suitable component concentrations for the article range from between about 55% and about 99% glass by weight of the article, up to about 40% clay by weight of the article, up to about 30% filler by weight of the article, between about 0.1% and about 5% porosity reducing agent by weight of the article, and between about 0.2% and about 3% binder by weight of the article. Particularly suitable component concentrations for the article range from between about 70% and about 99% glass by weight of the article, up to about 30% clay by weight of the article, up to about 20% filler by weight of the article, between about 0.1% and about 2% porosity reducing agent by weight of the article, and between about 0.2% and about 1% binder by weight of the article. More particularly suitable component concentrations for the article range from between about 80% and about 99% glass by weight of the article, up to about 20% clay by weight of the article, up to about 10% filler by weight of the article, between about 0.1% and about 2% porosity reducing agent by weight of the article, and between about 0.2% and about 3% binder by weight of the article. However, those skilled in the art will appreciate other suitable component concentration ranges for obtaining comparable properties of the article. Generally, as the weight percentage of glass in the composition increases, the translucency of the final article will also increase.

The size of the glass particles can affect the ability of the glass particles to form granular particles when combined with the other raw materials. Due to the “non-plastic” property of the glass particles, it can be difficult to bind them together. Even when bound together, the size of the glass particles affect the morphological, physical, and mechanical properties of the granular particles. For example, finer glass particles are more susceptible to interaction with water. In addition, while the strength of the resulting article increases when finer glass particles are used, the overall translucency of the article decreases. Depending on the size of the glass particles, the amount or type of binder may be adjusted to smoothly form the granular particles. Thus, the glass particles should be properly ground to most effectively form the article. In an exemplary embodiment, the glass particles are in the form of glass powder. In an exemplary embodiment, the glass particles have an average size of between about 20 microns and about 150 microns. In particular, the glass particles have an average size of between about 40 microns and about 70 microns.

Examples of suitable glass materials include, but are not limited to: soda-lime glass, borosilicate glass, and lead-alkali-silicate glass. The glass materials have various major chemical constituents and minor chemical constituents. Generally, major chemical constituents constitute a main portion of the composition of the glass and play a larger role in the overall properties of the glass while minor chemical constituents constitute a minor portion of the composition of the glass and play a smaller role in the overall properties of the glass. Major chemical constituents of soda-lime glass include silicon oxide (SiO₂), sodium oxide (NaO₂), and calcium oxide (CaO). Minor chemical constituents of soda-lime glass include aluminum oxide (Al₂O₃), magnesium oxide (MgO), ferrous oxide (Fe₂O₃), potassium oxide (K₂O), barium oxide (BaO), and chromium oxide (Cr₂O₃). Major chemical constituents of borosilicate glass include silicon oxide (SiO₂), sodium oxide (Na₂O), and boron oxide (B₂O₃). A minor chemical constituent of borosilicate glass includes aluminium oxide (Al₂O₃). Major chemical constituents of lead-alkali-silicate glass include silicon oxide (SiO₂), sodium oxide (Na₂O), and lead oxide (PbO). A minor chemical constituent of lead-alkali silicate glass includes calcium oxide (CaO).

Various kinds of waste glass can also be used in order to reduce cost. Examples of suitable sources of waste soda-lime glass include glass containers such as bottles. Examples of suitable sources of waste borosilicate glass include laboratory equipment. Examples of suitable sources of waste lead-alkali-silicate glass include glass light bulbs, fluorescent lamps, and glass lenses. The composition of the glass material making up the article of the present invention may include either one type of glass material or a combination of different types of glass materials.

Clay is included in the composition to perform three primary functions: to act as a binder, to strengthen the article prior to firing, and to enhance the mechanical properties of the final product. In particular, clay plays a role in the process of forming the granular particles by acting as a binder to maintain the components together. By acting as a binder, clay increases the strength of the article. In addition, clay enhances the surface hardness of the final article. Examples of suitable clays include, but are not limited to: kaolinite, shale, ball clay, montmorillonite, bentonite. In a particular embodiment, the average particle size of clay used to form the granular particles is between about 0.05 microns and about 95 microns. The composition of the clay making up the article of the present invention may include either one type of clay or a combination of different types of clay having an iron content less than about 0.5% of the total weight of the clays.

Fillers are added to the composition in order to create desired characteristics of the resulting product either by modifying original characteristics of components present in the composition to desired characteristics or by adding new characteristics not available from the presence of the other components. Examples of suitable fillers include, but are not limited to: color stain, alumina (Al₂O₃), silica (SiO₂), titanium oxide (TiO₂), zirconium oxide (ZrO₂), zirconium silicate (ZrSiO₄), zinc oxide (ZnO), and calcium silicate (CaSiO₄). Color stain fillers may be used for adjusting the color of the article. Alumina and silica filers may be used to improve the strength and the ability of the article to withstand scraping. In an exemplary embodiment, the filler particles are between about 10 microns and about 50 microns in size. The composition of the filler making up the article of the present invention may include either one type of filler or a combination of different types of fillers.

The composition of the article also includes a porosity reducing agent to prevent the formation of pores or voids in the article after the firing process. Reducing the formation of pores in the body of the article increases the density of the article and decreases the water absorption of the article. Examples of suitable porosity reducing agents include, but are not limited to, alkali metal salts such as sodium, lithium, and potassium chlorides. In an exemplary embodiment, the porosity reducing agent particles are between about 10 microns and about 1000 microns in size. The composition of the porosity reducing agent making up the article of the present invention may include either one type of porosity reducing agent or a combination of different types of porosity reducing agents.

The binder is used to form granular particles by maintaining the other raw material components in the composition together. The binder also functions to increase the strength of the article before the firing process so that the article can be easily transported into the kiln for firing without cracking. Examples of suitable binders include, but are not limited to: polyvinyl alcohol (PVA), polyvinyl acetate (PVAc), carboxymethyl cellulose (CMC), methylcellulose, ethylene vinyl acetate (EVA), starch, modified starch, and cellulose. A particularly suitable binder suspension mixture includes about 15% PVA by weight, about 31.5% kaolinite by weight, about 3% NaCl by weight, and about 50.5% water by weight. In an exemplary embodiment, the binder is water-soluble so that water can be used as the dispersion medium. The composition of the binder making up the article of the present invention may include either one type of binder or a combination of different types of binders.

Process

The sole FIGURE shows a method 10 of producing an article having translucent and stone-like properties according to the present invention. The raw material components of the article are first cleaned, Step 12. In particular, when waste glass is used, the glass particles must be cleaned in order to remove impurities. The glass, clay, filler, and porosity reducing agent are then prepared to the desired particle size before mixing, Step 14. Generally, glass is the main component of the composition in order to provide a translucent end product. In an exemplary embodiment, a dry milling method is used to grind the particles into the desired particle sizes. Any dry milling machine known in the art may be used, including, but not limited to: dry ball mills, jet mills, and pendulum mills.

Once the components are ground to the desired particle sizes, the components are placed on a mesh structure in a granulation chamber of a fluidized bed granulator, Step 16. The mesh structure allows air to flow through the chamber while still containing the components in a closed environment. Thus, the mesh size of the mesh structure must be smaller than the size of the finest components. As can be seen in Step 18, hot air is then passed through the granulation chamber and through the holes of the mesh structure. The hot air functions to dry the components as well as cause the components to disperse and mix with each other. Thus, the hot air is blown into the granulation chamber for an amount of time sufficient to thoroughly dry and mix the components. The amount of time the hot air is blown into the granulation chamber will depend on numerous factors including, but not limited to: the batch size of the granular particles to be produced and the capacity of the granulation chamber. In one embodiment, the temperature of the hot air is between room temperature and about 150° C. In particular, the temperature of the hot air is between about 80° C. and about 120° C.

After the glass, clay, filler, and porosity reducing agent are homogeneously mixed, binder is added to the mixture to form granular particles. The binder is prepared in liquid form (binder mixture) in order to facilitate introduction of the binder mixture into the granulation chamber and is housed in a container prior to being introduced into the granulation chamber. In an exemplary embodiment, the binder mixture is introduced into the granulation chamber from either a bottom nozzle spray located just above the mesh structure (i.e. spraying upwards) or from a top nozzle spray located far above the mesh structure (i.e. spraying downwards). The binder mixture is sprayed into the granulation chamber and contacts the other components, binding the components together to form granular particles, Step 20. The size of the resulting granular particles generally depends on the size of the droplets of the sprayed binder mixture and the amount of binder sprayed. The viscosity of the droplets of binder mixture will also affect the formation mechanism of the granular particles, potentially altering the size, distribution, shape, and strength of the resulting granular particles. As the temperature of the binder mixture decreases, the viscosity of the binder mixture increases, restraining the flow mechanism of the binder mixture in the piping system from which the binder mixture is sprayed. Thus, the temperature of the binder mixture may be controlled such that the binder mixture continuously flows through the spray nozzle. In an exemplary embodiment, the total weight of the binder mixture is about 20% of the weight of the dry components. In an exemplary embodiment, the viscosity of the binder mixture is between about 5 centipoise and about 3000 centipoise. In particular, the viscosity of the binder mixture is maintained at between about 100 centipoise and about 1000 centipoise.

Once the granular particles have formed to the desired size, the flow of binder mixture into the granulation chamber is stopped and hot air is passed through the chamber to dry the granular particles until the granular particles have a moisture content sufficient for the granular particles to flow continuously through a press feeding system of the fluidized bed granulator, Step 22. The ability of the granular particles to flow continuously through a piping system of the fluidized bed granulator is important to the dry pressing process. If the granular particles are not flowing continuously into the mold cavity, the amount of granular particles in the mold at each stroke of pressing cannot be controlled, resulting in variations in the thickness and density of the article. In one embodiment, the moisture content of the granular particles is between about 0.1% and about 4%. In particular, the resulting granular particles have a moisture content lower than about 1.5%.

In an alternative embodiment, the glass, clay, filler, and porosity reducing agent can also be individually prepared in liquid form and sprayed into the granulation chamber in a predetermined sequence and predetermined amount to form distinct layers. In this case, the suspension of the glass, clay, fillers, and porosity reducing agent are prepared in separate containers and are sprayed separately into the granulator chamber to form granules comprising various layers. This allows the granular particles to be prepared having particular layers of components by spraying those components in the desired sequence. By varying the granulation technique, the appearance of the resulting article can be altered due to the different morphologies of the components. However, when in liquid form, the flow rate of the components must be more particularly controlled. In order to control the flow rate of the components, modifying agents having particular characteristics may be added to the spray mixture. Examples of particular modifying agents include, but are not limited to: deflocculants, dispersants, floculants, defoaming agents, and surfactants.

In an exemplary embodiment, water is used as the liquid medium when the raw material components are prepared in liquid form. When water is used as the liquid medium, the porosity reducing agent is added in an amount sufficient to prevent or reduce the interaction between water and glass during granulation. The porosity reducing agent aids in preventing a dissolution reaction of the fine glass particles in the presence of water. The dissolution reaction results in water being retained within the glass particles. When the composition is fired, the resulting article can be very porous due to the pores and voids left in the article where the water is eliminated. The porosity reducing agent thus maintains the fired density of the product at a relatively high level. In an exemplary embodiment, the porosity reducing agent constitutes up to about 5% by weight of total liquid.

In addition to controlling the size and amount of binder introduced into the granulation chamber, the size of the obtained granular particles can also be selected by using mesh structures. Using mesh structures, granular particles that are smaller than the desired size can be collected and brought back through the granulation process. Likewise, granular particles that are larger than the desired size can be separated and broken down into smaller particles and also brought back through the granulation process. In an exemplary embodiment, the granular particles are between about 0.08 millimeters (mm) and about 5 mm in size and constitute less than about 1% by weight of the starting components.

After granulation, the formed granular particles are passed through a dry pressing process to form the granular particles into an article of a desired shape, Step 24. The size and shape of the article will thus depend on the size and shape of the pressing die. In an exemplary embodiment, the dry pressing process is performed in a 30×30 cm² pressing machine at a pressing pressure of between about 390 kg/cm² and about 420 kg/cm² to shape the article into a desired form.

If a patterned decoration is desired on the resulting article, the decoration may be formed by conventional ceramic decoration methods. The patterned decorations may be formed either before the dry pressing process by methods such as spreading, spraying, or applying the decoration materials on the surface or after the dry pressing process. Three-dimensional decorative patterns may also be formed on the surface of the shaped article by mixing various sizes and shapes of granular particles together in a desired proportion and spreading the granular particles on the surface of the article or by mixing the patterns with the raw materials before the dry pressing process. The decorations are typically formed on the outer layer of the article such that they are visible from an exterior surface of the article and may consist of various types of materials including, but not limited to: granular particles, coarse transparent glass particles, and compacted granular particles.

Further decorations can be accomplished by introducing an interlayer between the outermost layers of the article. Because the resulting article has translucent properties, the interlayer may be designed as a pattern that can been seen through the outermost layer. Three-dimensional decorative patterns may also be formed between product layers by imprinting, spreading, or spraying color stain, color frit, or colored glass powder either by wet or dry means between the layers before the dry pressing process. This process can produce more than one layer.

After the article is shaped through the dry pressing process, the shaped article is placed in a kiln on a refractory slab to prevent the shaped article from deforming during the firing process and to prevent the shaped article from sticking to the furnace surface, Step 26. The surface of the kiln furniture may optionally be coated with a flame-retardant. During the firing process, the binder is removed (decomposes) from the article at a relatively low temperature. Binder removal can become difficult at temperatures higher than 700° C., especially in a fast firing process or when using a roller kiln. When the article is being fired, the body of the article becomes more dense as the temperature rises. Thus, if the binder that is being burned off (in gaseous form) becomes trapped within the body of the article, the article may crack or may explode in order to release the binder. In an exemplary embodiment, the shaped article is fired at a maximum temperature of between about 700° C. and about 1500° C., depending on the composition of the article. In particular, the shaped article is fired at a maximum temperature of between about 800° C. and about 1100° C. The temperature and duration of the firing process will depend on the composition of the article, the amount of the binder used, and the size of the article. For example, as the amount of glass particles present in the composition increases, the firing temperature may be decreased. As the amount of binder in the composition increases, the duration of time in which the article is exposed to the firing process should be increased in order to ensure removal of the binder from the final product. After firing, the shaped article is then polished to enhance the aesthetic look of the surface. The interlayer decorations may also become more clearly visible after polishing.

In a first exemplary embodiment, the raw material components included about 96% glass by weight, about 1% porosity reducing agent by weight, and about 3% binder by weight. After thorough mixing and pressing, the composition was heated at a temperature of between about 450° C. and about 700° C. for about 3 hours to ensure that the binder was completely burned out. The composition was then heated to a maximum temperature of about 800° C. for about 1 hour. The resulting article exhibited excellent translucency (the resulting articles were given translucency ratings of excellent, good, or fair), a surface hardness of 4 in Moh's scale, modulus of rupture greater than 400 kg/cm², and a water absorption of about 0.03%. In a second exemplary embodiment, the raw material components included about 93.45% glass by weight, about 5% clay by weight, about 0.35% porosity reducing agent by weight, and about 1.2% binder by weight. After thorough mixing and pressing, the composition was heated at a temperature of between about 880° C. and about 950° C. for about 1 hour. The resulting article exhibited good translucency, a surface hardness of 5 in Moh's scale, modulus of rupture greater than 400 kg/cm², and a water absorption of about 0.03%. In a third exemplary embodiment, the raw material components included about 82.4% glass by weight, about 10% clay by weight, about 5% filler by weight, about 2% porosity reducing agent by weight, and about 0.6% binder by weight. After thorough mixing, the composition was heated at a temperature of between about 1080° C. and about 1100° C. for about 30 minutes. The resulting article exhibited fair translucency, a surface hardness of 6 in Moh's scale, modulus of rupture greater than 400 kg/cm², and a water absorption of about 0.04%. All other variables, such as particle size and binder viscosity, remained constant throughout the examples.

After the article has been fired, new constituents, or new phases, are formed. The new constituents that are formed are based on the raw material components of the article as well as the amount of each raw material component. In an exemplary embodiment, the fired article may consist of various kinds of new constituents, including, but not limited to: alumino silicate crystallines, calcium silicate crystallines, silicon dioxide crystallines, and other amorphous phases. Alumino silicate crystallines include compounds that mainly comprise aluminium, silicon and oxygen. Calcium silicate crystallines include compounds that mainly comprise calcium, silicon and oxygen. Examples of silicon dioxide crystallines include, but are not limited to: cristobalite and quartz. Examples of amorphous constituents include non-crstayllines that mainly comprise aluminum, silicon, calcium, and oxygen. The amount of each new constituent depends on the amount of each starting raw material component and the parameters of the firing process (e.g. temperature and time). In an exemplary embodiment, the resulting article has a modulus of rupture of greater than about 400 kg/cm² and a water absorption of lower than about 0.1%.

The method of manufacturing articles having translucent and stone-like properties of the present invention reduces the amount of energy consumed during the granulation process by adopting fluidized bed granulation and reduces the firing temperature to lower than about 1100° C. The resulting article has characteristics that are substantially similar to the characteristics of clay-based ceramic articles. For example, an article formed from the method of the present invention will have comparable strength, resistance to chemical attack, and resistance to staining as a clay-based ceramic article. Moreover, the article may exhibit translucent properties, resulting in an article having a translucent and natural or stone-like appearance.

Although the present invention has been described with reference to preferred embodiments, workers skilled in the art will recognize that changes may be made in form and detail without departing from the spirit and scope of the invention.

The following is claimed:

1. A method of manufacturing an article comprising the steps of:
granulating glass, clay, filler, and porosity reducing agent by fluidized bed granulation to form a mixture;
adding binder to the mixture to form granular particles having an average particle size of between about 0.08 millimeters and about 5 millimeters;
forming the granular particles into a shaped article by dry pressing;
drying the shaped article; and
firing the shaped article in a kiln at a maximum temperature of between about 800° C. and about 1100° C.;
wherein the granular particles comprise between about 55% to about 99% glass by weight, up to about 40% clay by weight, up to about 30% filler by weight, between about 0.1% and about 5% porosity reducing agent by weight, and between about 0.2% and about 3% binder by weight.

2. The method according to claim 1, wherein the glass is selected from the group consisting of: soda-lime glass, borosilicate glass, and lead-alkali-silicate glass.

3. The method according to claim 2, wherein the glass has an average particle size of between about 20 microns and about 150 microns.

4. The method according to claim 1, wherein the clay is selected from the group consisting of: kaolinite, shale, ball clay, montmorillonite, and bentonite.

5. The method according to claim 1, wherein the filler is selected from the group consisting of: color stain, alumina, silica, titanium oxide, zirconium oxide, zirconium silicate, zinc oxide and calcium silicate.

6. The method according to claim 1, wherein the porosity reducing agent is an alkali metal salt selected from the group consisting of: sodium, lithium, and potassium.

7. The method according to claim 1, wherein the binder is selected from the group consisting of: polyvinyl alcohol, polyvinyl acetate, carboxymethyl cellulose, methylcellulose, ethylene vinyl acetate, starch, modified starch, and cellulose.

8. The method according to claim 1, wherein the binder has a viscosity of between about 5 centipoise and about 3000 centipoise.

9. The method according to claim 1, wherein the granular particles have a moisture content of between about 0.1% and about 4%.

10. The method according to claim 1, wherein each of the glass, clay, filler and porosity reducing agent is individually prepared in liquid form and introduced in a predetermined sequence and predetermined amount into a granulation bed.

11. The method according to claim 1, wherein the glass, clay, filler, porosity reducing agent, and binder are mixed together to form a slurry, and wherein the slurry is sprayed into the granulation bed

12. The method according to claim 1, and further comprising decorating the article.

13. An article produced by the method according to claim 1.

14. The article according to claim 13, wherein the article has modulus of rupture greater than about 400 kg/cm².

15. The article according to claim 13, wherein the article has a water absorption of less than about 0.1%.

16. The article according to claim 13, wherein the article is translucent.

17. A method of manufacturing an article comprising the steps of:
introducing glass and porosity reducing agent into a fluidized bed granulator;
granulating the glass and porosity reducing agent to form a mixture;
adding binder to the mixture to form granular particles;
forming the granular particles into a shaped article;
drying the shaped article; and
firing the shaped article in a kiln at a temperature of less than about 1500° C.;
wherein the article has a water absorption of less than about 1%.

18. The method according to claim 17, wherein introducing glass and porosity reducing agent and granulating the glass and porosity reducing agent further comprises introducing clay and filler and granulating clay and filler.

19. The method according to claim 18, wherein the granular particles comprise between about 55% to about 99% glass by weight, up to about 40% clay by weight, up to about 30% filler by weight, between about 0.1% and about 5% porosity reducing agent by weight, and between about 0.2% and about 3% binder by weight.

20. The method according to claim 17, wherein the granular particles have an average particle size of between about 0.08 millimeters and about 5 millimeters.
